(19) United States
(12) Patent Application Publication
(10) Pub. No.: US 2003/0035462 A1
(43) Pub. Date: Feb. 20, 2003

(54) Method and apparatus for measuring the level of the contents

(76) Inventor: Paul-Andre Savoie, Laval (CA)

Correspondence Address: Gowling Lafleur Henderson LLP, Suite 2600, 160 Elgin Street, Ottawa, ON, K1P 1C3, CA

(21) Appl. No.: 10/223,323

(22) Filed: Aug. 20, 2002

Related U.S. Application Data
(60) Provisional application No. 60/313,107, filed on Aug. 20, 2001.

(51) Int. Cl. G01K 1/02

(52) U.S. Cl. 374/141

(57) ABSTRACT

The level detection device has a heat sensitive device, a heat device, and a processor for controlling the operation of measurement. The level detection device is externally mounted to tanks. The level detection device heats the heat sensitive device and monitors the output of the heat sensitive device. The date obtained by the level detection device is transferred to an external device.

### FIELD OF THE INVENTION

The invention relates to measuring devices, and more particularly to a method and a device for measuring the level of the contents within a tank, a reservoir or a container.

### BACKGROUND OF THE INVENTION

Many invasive systems have been devised for measuring the contents of tanks or reservoirs.

However, it is still difficult to measure the level precisely while meeting need of low power consumption. Further, it is difficult to install the systems to the tank when the system must be internally mounted into the tanks or reservoirs. Finally, it is not practical to have to go to the tank or reservoir to know the level of the contents.

Therefore, it is desirable to provide a device that can measure the level of the contents within the tanks or the reservoirs precisely with low power consumption, and that works with thick walled as well as thin walled tanks or reservoirs

It is also desirable to provide a device that can be easily installed to the tanks or reservoirs, which is compatible with any tank or reservoir and for the installation of which no modifications has to be made to the existing tank or reservoir.

It is also desirable to provide advice that can convert the level reading into a signal that can be fed into a telemetry device to relay the level value.

### SUMMARY OF THE INVENTION

It is an object of the invention to provide a novel system and method of measuring the level of the contents within tanks or reservoirs, which obviates or mitigates at least one of the disadvantages of existing systems.

The device of the present invention uses a heat sensitive device and a heat device which are externally mounted on the tanks. The power is supplied to the device when measuring (monitoring, detecting) process is triggered.

In accordance with an aspect of the present invention, there is provided a device for measuring a level of a content within a tank. The device includes one or more heat sensitive devices, each of which sensing a temperature, one or more heat device for supplying heating to the heat sensitive devices; and a processor for detecting the level based on the output of the heat sensitive devices. The heat sensitive devices and the heat devices is externally mounted on the tank.

In accordance with another aspect of the present invention, there is provided a method of measuring a level of a content within a tank. The method includes the steps of: receiving a trigger signal; supplying heat to a heat sensitive device through a heat device based on the trigger signal, the heat sensitive device being externally mounted on a tank and sensing a temperature; and monitoring an output of the heat sensitive device to detect a level of a content of the tank.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The invention will be further understood from the following description with reference to the drawings in which:

FIG. 1 is a block diagram showing a level detection device 100 in accordance with one embodiment of the present invention;

FIG. 2 is a schematic diagram showing one example of the level detection device 100 of FIG. 1;

FIG. 3 is a schematic diagram showing a package for the level detection device 100 of FIG. 2;

FIG. 4 is a diagram showing one example of the heat device 102 and the heat sensitive device 104 of FIG. 2;

FIG. 5 is a flow chart showing one example of the operation for the level detection device 100;

FIG. 6 is a diagram showing a level detection device 200 in accordance with another embodiment of the present invention;

FIG. 7 is a diagram showing another example of the level detection device 200;

FIG. 8 is a flow chart showing the operation of the level detection device 200 in accordance with one embodiment of the present invention.

### DETAILED DESCRIPTION OF THE PREFERRED EMBODIMENTS

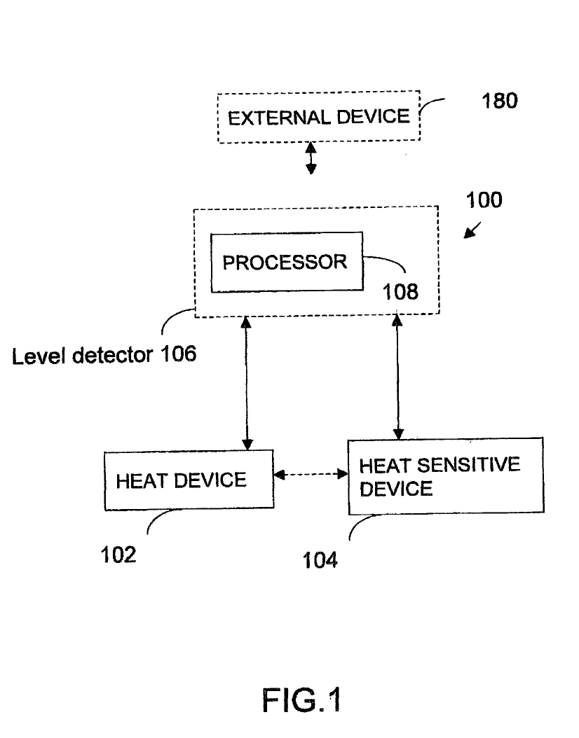

FIG. 1 shows a level detection device 100 in accordance with one embodiment of the present invention. The level detection device 100 detects the level of the contents within tanks. The tank may be a gas tank, such as a propane tank or a liquid tank. The tank may be implanted. The level detection device 100 is externally mounted on the outside surface of the tank. It may be applied to vertical or horizontal tanks. The tank may be a thin or thick tank.

The level detection device 100 includes a heat device 102, a heat sensitive device 104, and a level detector 106.

The heat device 102 supplies heat to the heat sensitive device 104. The heat device 102 may be a coil, flexible heaters strip made of Kapton, silicon rubber, mica or resistor (such as Ohmite resistor 810F50R™, Panasonic ECG ERJ-1TYJ470U, 511U and 561U™, Omega KHLV-0502/10™). Operating temperature range may be about −30° C. to 45° C.

In FIG. 1, the level detection device 100 includes one heat device 102. However, the level detection device 100 may include more than one heat device 102. More than one heat devices may shorten heating time, and thus lower power consumption.

The heat sensitive device 104 may include one or more heat sensitive elements that can detect a temperature. The heat sensitive device 104 may include an analog device that changes its physical condition in response to the temperature and outputs a current or voltage showing its conditions. The heat sensitive device 104 may include a digital device, which outputs a digital signal showing the temperature.

For example, the heat sensitive device 104 may include a thermistor, a thermocouple, or a semiconductor, such as Analog Device TMP36™, Microchip TC1047A™, National semiconductor LM50™.

It is preferable to use the heat sensitive device whose output is linearly proportional to the measured temperature.

In FIG. 1, the level detection device 100 includes one heat sensitive device 104. However, the level detection device 100 may include more than one heat sensitive device 104. The number of the heat sensitive elements (or the heat sensitive devices) can be varied based on the size of the tanks and the precision of result required.

The level detector 106 includes a processor 108 which controls the operation of the level detection device 100, such as heating time, cooling time, heating point or detecting (measuring, monitoring) timing, and detects an information signal from the heat sensitive device 104. The level detector 106 processes the information and transfers data to an external device 180. The level detector 106 can convert the data to supply it to the external device 180. For example, the data may be converted into a 4 to 20 mA signal to supply the data to external device 180.

The external device 180 may be a computer. The external device 100 activates and deactivates the level detection device 100. The power is supplied to the level detection device 100 only in measuring (monitoring) phase as described below. The power management insures lower power consumption. The external device may have a database which records data obtained by the level detection device 100. The database may record analysis result, such as the characteristic of the heat device 102 or the heat sensitive device 104.

The external device 180 determines the level of the contents within the tank, records data, analyses the data and programs the level detector 180. Alternately, the level detector 106 may include functionality of the external device 180, such as determining the level of the contents within the tank, recording data, analysing the data.

The signal output from the level detection device 100, for example the 4 to 20 mA signal, may be supplied to a telemetry device through a wireless connection or a wired connection.

The level detection device 100 may have a device for displaying the measurement results as visual data.

The level detection device 100 further includes a chemical adhesive material, such as a thermally conductive silicone, tape with thermal compound or epoxy (such as Omega OB-101-2™), for installing the level detection device 100 to the surface of the tank. The level detection device 100 can be easily and quickly installed on the tank with the chemical adhesive material. This material insures thermal contact between the tank and the level detection device 100.

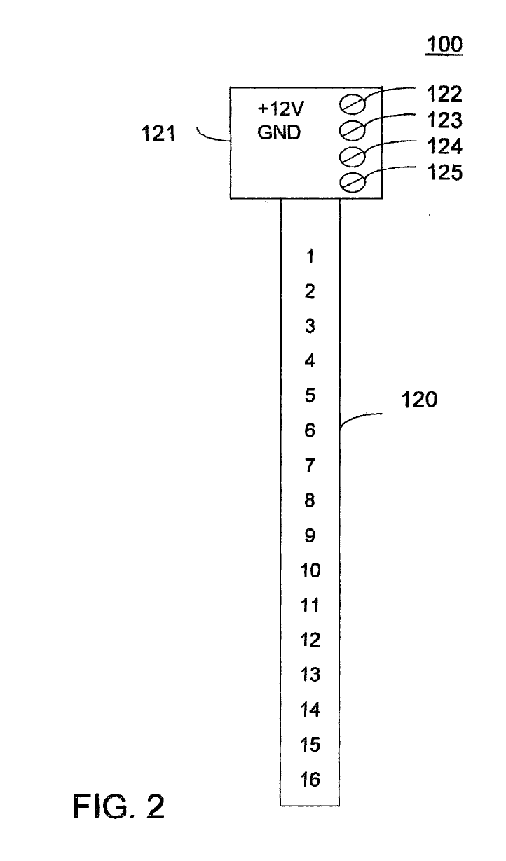

FIG. 2 shows one example of the level detection device 100 of FIG. 1. The level detection device 100 in FIG. 2 includes the heat sensitive device (104 of FIG. 1) having a plurality of heat sensitive elements 1 to 16. The heat sensitive elements 1 to 16 are connected in parallel. The heat sensitive elements 1 to 16 include thermistors as described below. The heat sensitive elements are mounted on a flexible elongated Printed Circuit Board (PCB) 120. In FIG. 2, 16 heat sensitive elements are shown, however, any number of the heat sensitive elements can be available.

The level detection device 100 further includes an enclosure 121. The enclosure 121 is water-proofed. The enclosure 121 is fixed to the PCB 120. The enclosure 121 contains the level detector (106 of FIG. 1), which controls the operation of the device and detects the resistance of the thermistors to determine the level of the contents of the tank.

The enclosure 121 further includes a plurality of terminals 122 to 125 which may be mounted inside watertight access holes. Power is supplied to the device mounted on the PCB 120 through the terminal 122. The level detection device 100 may obtain the power supply from solar panels battery charging circuit. The terminal 123 is a ground terminal. The terminals 124 and 125 can be connected to an external device (180 of FIG. 1).

The external device (180) renders the interrupt terminal 124 a first level (such as a low level) for informing the processor (108) that the external device requests the measurement process. When the interrupt terminal 124 is a low level, the level detection device 100 starts the measurement process.

Once the processor (108) terminates the measurement process, the level detector (106) outputs level measurement result from the output terminal 125. The level measurement result may be transmitted as a series of binary data to the external device (180). The level detection device 100 can output the level measurement result as 4 to 20 mA signal from the output terminal 125.

When the external device (180) has received the level measurement result, the external device (180) renders the interrupt terminal 124 a second level (such as a high level). The measurement process is restarted when the external device (180) changes the second level (high voltage) of the interrupt terminal 124 to the first level (low voltage).

Heating is supplied only when data is measured (monitored) with the heating environment. This measurement method can keep the level detection device 100 in power down mode while no measurements are requested by the external device (180). Further, as this method insures minimum power consumption from the power supply source, the level detection device 100 can obtain the power from the power source, such as the solar panels battery charging circuit.

The level measurement result may include level data which represents the date (day and time) on which the level measurements have been done on the tank, and level reading data which is the liquid level measured by the measurement process. The reading data may be represented as centimeter, % or liter.

In FIG. 2, the level detection device 100 includes one data terminal 125. However, the level detection device 100 may have more than one data terminal.

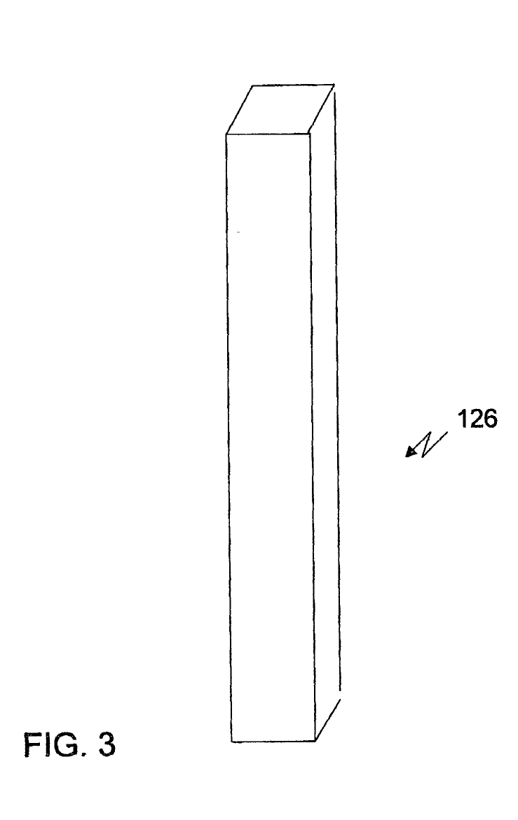

The heat sensitive device (104) with the PCB 120 and the heat device (102) are encased within a material 126 as shown in FIG. 3 such as a flexible foam insulation which allows the level detection device 100 to be flexibly mounted in close contact with the tank and at the same time thermally insulate the heat sensitive device from the environment allowing it to respond to temperature changes of the tank itself. The level detection device (100) may be encased.

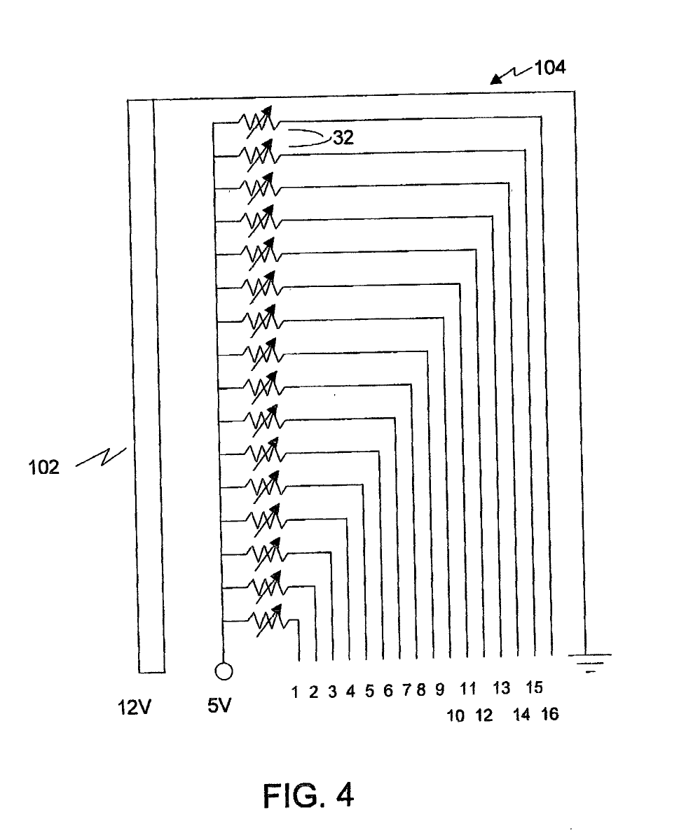

FIG. 4 shows one example of the heat device 102 and the heat sensitive devices 104 of FIG. 2. In FIG. 4, an electrical circuitry is exemplified as the heat sensitive devices 104. The heat sensitive device 104 includes heat sensitive elements 1 to 16, each of which includes a thermistor 32. The thermistor 32 changes its resistance depending on temperature. All of the thermistors are attached on the tanks in the same manner.

The heat device 102 is a strip heater. The heat device 102 heats the thermistors. The heat device 102 is provided to the thermistors in parallel such that the overall of the therminstors can be heated.

The heat device 102 may have a plurality of the heat elements corresponding to the thermistors such that the each heat device element can heat the corresponding heat sensitive element.

The heat sensitive elements 1 to 16 may be mounted directly on the surface of the heat device 102. However, the heat sensitive device 104 (or elements 1 to 16) may be separated from the heat device 102 on the tank surface.

The distance between the heat sensitive elements 1 to 16 and the heat device 102 may be determined based on sensitivity, heating power or heating time.

The distance between the sensing points, i.e., the distance between the heat sensitive elements 1 to 16 may be determined based on the resolution required and dimension of the level detection device (100).

The heat device 102 has terminals for connection to the power supply terminal (122) and the negative (ground) terminals (123) and a terminal for connection to the processor (108). The power supply may be 12 to 24 volts. The duration of heating and the timing of measurement are controlled by the processor (108).

The operation of the level detection device in accordance with the embodiment of the present invention is now described. In one embodiment, the operation includes a heating phase in which the heat device 102 is activated, and a cooling phase in which the heat device 102 stops its operation.

During the cooling phase, the measurement process (sensing process) is carried out. However, the measurement process can be carried out in the heating phase. The measurement process may be repeated during one cooling phase. The combination of the heating phase and the cooling phase may be repeated.

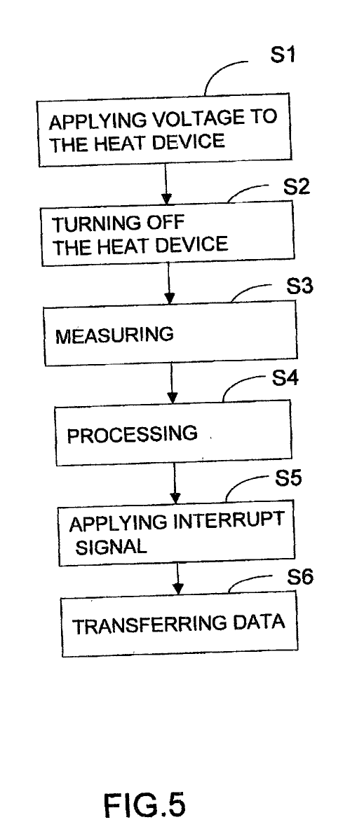

FIG. 5 is a flow chart showing one example of level detection process in accordance with one embodiment of the present invention.

Referring to FIGS. 1 to 5, in step S1, the heat device 102 provides heating such that all of the heat sensitive elements are heated to the same degree. When the level detection device 100 has a plurality of the heat devices, all of the heat devices are activated at the same time.

For example, 12 to 24 volt, maximum 1 amp, voltage is applied to the heat device 102. The heat device 102 heats the tank until all thermistors are at a temperature at + or −2% within one another.

In step S2, after a specific period of time, the heating device 102 stops its operation such that all of the heat sensitive elements are cooled at the same time. The tank or reservoir near each heat sensitive element loses heat at a rate that is determined by the substance, such as liquid or gaseous, in contact with the inside of the tank.

In step S3, after a specific period of time, measurement process is started. As for the thermistor 32, the resistance of each thermistor 32 is measured. The level of the contents in the tank is determined by detecting the level at which the thermistors have a substantially different resistance.

For example, the thermistors which are in contact with the portion of the tank that is itself in contact with a liquid in the tank will cool faster than the thermistors which are in contact with the portion of the tank that is itself in contact with air or a gas, and will therefore exhibit a substantially different resistance. Thus the level of the interface between the two substances will be determined by the difference of resistance of the thermistors above and below this interface.

In step S4, the level detector 106 processes data based on the measurement. In step S5, an interrupt signal is applied to the terminal 124 that Informs the external device 180 that data is ready for transmission from the data terminal 125. In step S6, the data is transferred to the external device 180.

As described above, the measuring step S3 can be included in the heating step S1. The measuring step S3 can be repeated in the heating step S1 or in the cooling step S2.

The level detection device 100 may further be programmed to make measurements and transmit data periodically. Alternately it may be programmed such that the process from step S1 to step 6 is repeated In this case, the voltage is removed and re-applied to the 12 to 24 v terminal 122. The external device 180 may determine the level based on a plurality of measurement results.

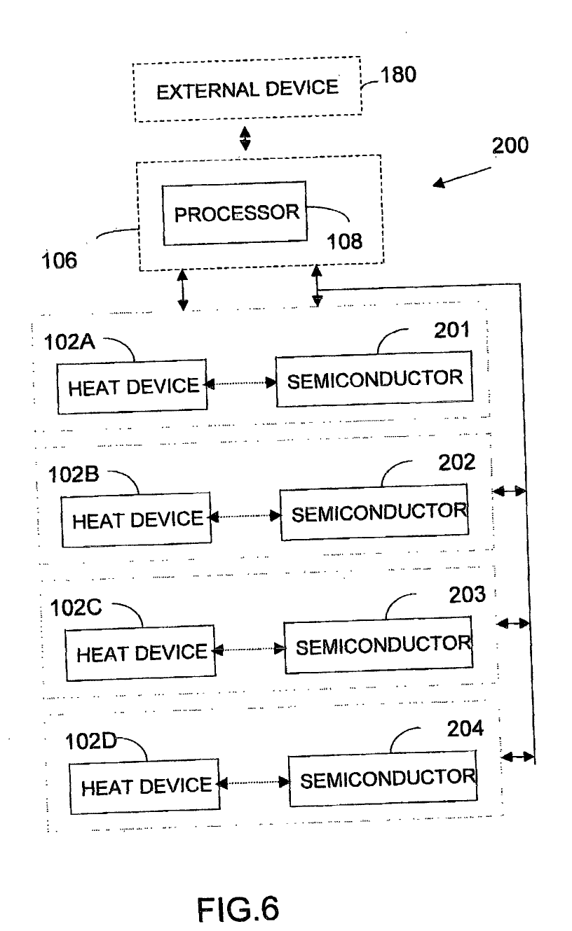

FIG. 6 shows a level detection device 200 in accordance with another embodiment of the present invention. The level detection circuit 200 in FIG. 5 has a plurality of the heat sensitive elements 201 to 204 (i.e., a plurality of sensing points) and a plurality of the heat devices 102A to 102D (i.e., a plurality of heating points). The heat sensitive elements 201 to 204 are digital devices, such as semiconductor sensors. The semiconductor sensors can outputs the sensing result linearly proportional to the measured temperature.

The heat devices 102A to 104D heat the heat sensitive elements 201 to 204, respectively. The processor 108 may communicate with each heat sensitive element and each heat device separately. The heat devices 102A to 102 D can be separately activated. It may be preferable to heat all the heat sensitive elements at the same time.

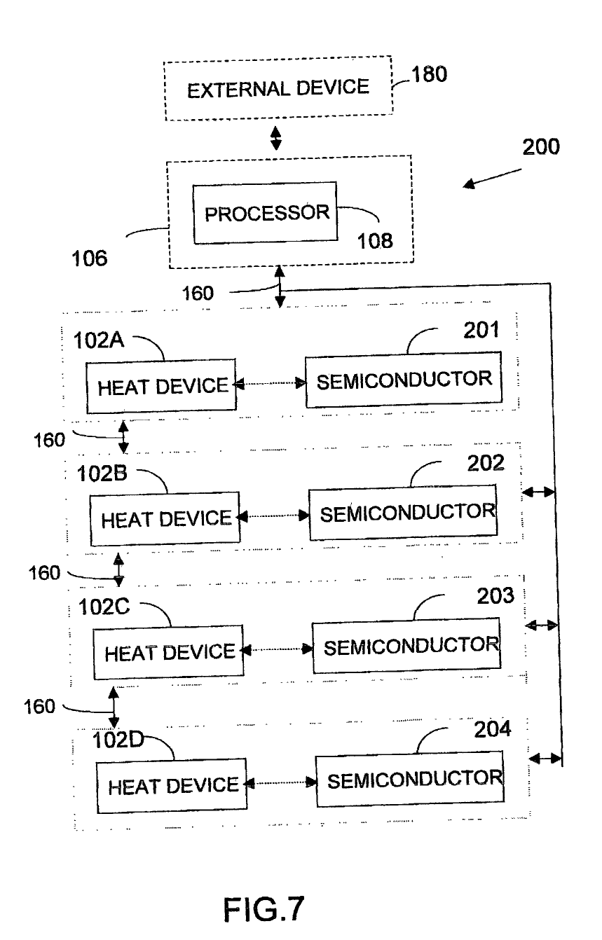

FIG. 7 shows another example of the level detection device 200. In FIG. 6, the heat sensitive elements 201 to 204 and the level detector 106 are connected through cables 160. The cables 160 may allow the heat sensitive elements 201 to 204 to be easily positioned to sensing points.

In FIGS. 6 and 7, one heat device is provided for one heat sensitive element. However, the heat device and the heat sensitive element (or heat sensitive device) may be arranged to meet one to many, many to one or many to many relationships as well as one to one relationship. Also, the level detection device 200 may one heat device and one semiconductor sensor.

In FIGS. 6 and 7, the semiconductor sensor may be mounted directly on the surface of the heat device. However, the semiconductor sensor may be separated from the heat device on the tank surface.

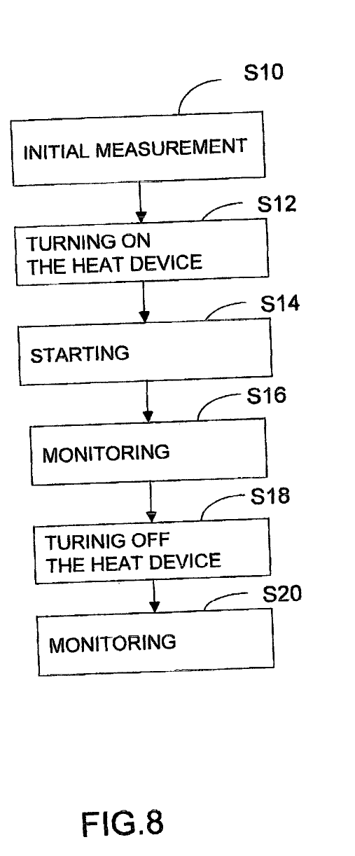

FIG. 8 is a flow chart showing the operation of the level detection device 200 in accordance with one embodiment of the present invention.

Referring to FIGS. 6 to 8, in step S10, the initial temperature of the tank is measured before heating. In step S12, the heat devices 102A to 102 D are turned on. In step S14, the monitoring (or measurement) is started.

In step S16, the change of the temperature, i.e., the change (ΔT) from the initial temperature to the temperature after heating is monitored, since the change (ΔT) of the heat sensitive element at the non-liquid area is different from that of the heat sensitive element at the liquid area. The change (ΔT) of the heat sensitive element at the non-liquid area may be higher than that of the heat sensitive element at the liquid area. The monitoring process is continued until ΔT showing the non-liquid area is detected.

In step S18, the heat devices 102A to 102 D are turned off. The level detection device 200 continues temperature monitoring to confirm that the level has been already detected (in step S20).

As the change ΔT in a cooling phase is different depending on where the heat sensitive element is mounted. The change in the cooling phase also can be utilized for detection of the level.

In another embodiment, the measurement process may be carried out during the heating phase. The measurement process may be repeated during one heating phase. Also, various arrangements of heating devices and heat sensitive elements may be used to further refine the measurements.

The level detection devices in accordance with the embodiments of the present invention can be applied to think tanks as well as thin tanks. The level detection device in accordance with the embodiments of the present invention can fulfill the need of low cost retrofittable and low powered consumption and can be easily installed on industrial, commercial or residential tanks.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A device for measuring a level of a content within a tank, the device comprising:
one or more heat sensitive devices, each of which sensing a temperature,
one or more heat device for supplying heating to the heat sensitive devices; and
a processor for detecting the level based on the output of the heat sensitive devices,
the heat sensitive devices and the heat devices being externally mounted on the tank.

2. The device of claim 1, wherein the heat device is mounted on the tank with a chemical adhesive material.

3. The device of claim 1, wherein the content of the tank is liquid.

4. The device of claim 1, wherein the content of the tank is gas.

5. The device of claim 1, wherein the heat sensitive element is a semiconductor.

6. The device of claim 1, wherein the heat sensitive element is a thermistor.

7. The device of claim 1, wherein the heat device is provided to the corresponding heat sensitive element.

8. The device of claim 1 further comprising an external device for controlling a detection process in the processor to cause the processor to start the detection process and to end the detection process.

9. The device of claim 8, wherein the heat device is activated only when the detection process is implemented.

10. The device of claim 9, wherein the heat device obtains a power supply from a solar panels battery charging circuit.

11. The device of claim 1, wherein the detection result in the processor is output to an external device as a signal.

12. The device of claim 11, wherein the signal is 4 to 20 mA.

13. The device of claim 11, wherein the signal is supplied to a telemetry device to relay the detection result through a wireless connection.

14. The device of claim 11, wherein the signal is supplied to a telemetry device to relay the detection result through a wired connection.

15. The device of claim 1, wherein a number of the heat sensitive device is determined based on a size of the tank.

16. The device of claim 1, wherein a number of the heat sensitive device is determined based on a size of the tank.

17. The device of claim 2, wherein a number of the heat sensitive device is determined based on a size of the tank.

18. The device of claim 2, wherein a number of the heat sensitive device is determined based on a precision of the detection.

19. The device of claim 17 further comprising an external device for controlling a detection process in the processor to cause the processor to start the detection process, and to end the detection process, and wherein the heat device is activated only when the detection process is implemented.

20. The device of claim 18 further comprising an external device for controlling a detection process in the processor to cause the processor to start the detection process and to end the detection process, and wherein the heat device is activated only when the detection process is implemented.

21. The device of claim 19, wherein the heat sensitive device is a semiconductor.

22. The device of claim 20, wherein the heat sensitive device is a semiconductor.

23. The device of claim 1, wherein the processor monitors the output of the heat sensitive element when the heating is supplied to the heat sensitive element.

24. The device of claim 23, wherein the heat device is activated only when the detection process is implemented.

25. The device of claim 1, wherein the processor monitors the output of the heat sensitive element when the heating is stopped.

26. The device of claim 25, further comprising an external device for controlling a detection process in the processor to cause the processor to start the detection process and to end the detection process, and wherein the heat device is activated only when the detection process is implemented.

27. The device of claim 26, wherein the heat sensitive device is a semiconductor.

28. The device of claim 1, wherein the processor monitors a change of the temperature between an initial temperature measured before heating and a temperature after heating.

29. The device of claim 28, further comprising an external device for controlling a detection process in the processor to cause the processor to start the detection process and to end the detection process, and wherein the heat device is activated only when the detection process is implemented.

30. The device of claim 29, wherein the heat sensitive device is a semiconductor.

31. The device of claim 26, wherein the heat device is mounted on the tank with a chemical adhesive material.

32. The device of claim 29, wherein the heat device is mounted on the tank with a chemical adhesive material.

33. A method of measuring a level of a content within a tank, the method comprising:
receiving a trigger signal;
supplying heat to a heat sensitive device through a heat device based on the trigger signal, the heat sensitive device being externally mounted on a tank and sensing a temperature; and
monitoring an output of the heat sensitive device to detect a level of a content of the tank.

34. A method of claim 33 further comprising the step of deactivating the heat device after the level is determined.

35. A method of claim 34, wherein the monitoring step is implemented when heating is supplied.

36. A method of claim 34, wherein the monitoring step is implemented after deactivating the heat device.

37. A method of claim 33 further comprising the step of receiving an end signal from an external device to deactivate the heat step.

38. A method of claim 33, wherein the monitoring step is carried out periodically.

39. A method of claim 33, wherein the supplying step and the monitoring step are carried out repeatedly.

40. A method of claim 33, wherein the heat device includes a plurality of heat elements and the supplying step includes the step of activating the heat devices at the same time.

41. A method of claim 33, wherein the heat sensitive device include a plurality of heat sensitive devices and the supplying step supplies heat such that the heat sensitive devices are heated at the same timing.

42. A method of claim 33 further comprising the step of monitoring an output of the heat sensitive device for obtaining an initial temperature before heating.

43. A method of claim 42, wherein the step of monitoring an output of the heat sensitive device includes the step of comparing the output of the heat sensitive device after heating and the output of the heat sensitive device before heating.
